(19) United States
(12) Patent Application Publication
(10) Pub. No.: US 2009/0294539 A1
(43) Pub. Date: Dec. 3, 2009

(54) System and Method for Authentication Using a Bar-Code

(76) Inventor: Dong-Gyu Kim, Seoul (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/295,748

(22) PCT Filed: Jan. 18, 2007
(86) PCT No.: PCT/KR07/00288

§ 371 Date: Oct. 2, 2008

(30) Foreign Application Priority Data
Apr. 7, 2006 (KR) 10-2006-0032037
Apr. 24, 2006 (KR) 10-2006-0036751
Sep. 4, 2006 (KR) 10-2006-0084508

(51) Int. Cl. G06K 7/10

(52) U.S. Cl. 235/462.01

(57) ABSTRACT

The present invention relates to the authentication system and method which can be utilized as means for person identification and/or commercial payment method using a bar code containing personal information which is created in real-time through a mobile terminal.

The bar code authentication system of the present invention comprises a bar code reader for recognizing and interpreting a bar code created by a mobile terminal, and transmitting bar code recognition information containing the recognition time of the recognized bar code and bar code interpretation information containing the creation time of the interpreted bar code; and a main server for verifying validity of the bar code using the recognition time of the bar code and the creation time of the bar code.

### TECHNICAL FIELD

The present invention relates to the authentication system and method which can be utilized as means for person identification and/or commercial payment method using a bar code containing personal information which is created in real-time through a mobile terminal.

### BACKGROUND ART

Since a conventional fixed type mobile bar code that is authenticated once by a remote authentication server is transmitted to and used by a mobile terminal of an individual, it can be photographed by a digital camera and displayed on a screen, or can be printed and used as an identification and/or authentication method. Hence, a fixed type mobile bar code can be forged or falsified.

Accordingly, services based on the conventional fixed type bar code technique are very limited to issuing tickets, coupons, and the like. Further, the fixed type mobile bar code is restrictively used or cannot be utilized in the business area where security is regarded as important, such as issuing membership cards, cash cards, or the like.

In order to partially dress and solve the above problems, a user has to access to a remote server through the Internet each time he/she needs to be use a bar code, and downloads and uses a bar code containing information such as in a cash card or a membership card that needs to be repeatedly used. However, it is still vulnerable in security, and additional costs are required so as to connect to the remote authentication server.

In addition, one time password (OTP) codes are created and used in the form of a bar code in order to further enhance security in electronic commerce using bar codes. However, only an OTP code is simply created and used in the form of a bar code, and thus it is inconvenient in that personal information required for payment should be separately inputted through a payment device.

### DISCLOSURE

### [Technical Problem]

The present invention has been made in an effort to solve the above problems, and it is an object of the present invention to provide a bar code authentication system and method, in which a mobile terminal receives a bar code generating program, creates a bar code in real-time, and utilizes it for person identification.

Another object of the invention is to provide a bar code authentication system and method, in which a bar code is created by adding an OTP code to a bar code containing personal information and being created in real-time in a mobile terminal.

### [Technical Solution]

In order to accomplish the above objects of the present invention, according to one aspect of the present invention, there is provided a bar code authentication system comprising: a bar code reader for recognizing and interpreting a bar code created by a mobile terminal, and transmitting bar code recognition information containing a recognition time of the recognized bar code and bar code interpretation information containing a creation time of the interpreted bar code; and a main server for verifying validity of the bar code using the recognition time of the bar code and the creation time of the bar code.

According to another aspect of the present invention, there is provided a bar code authentication system comprising: a bar code reader for recognizing and interpreting a bar code created by a mobile terminal, and verifying validity of the bar code using a recognition time from the recognized bar code and a creation time from the interpreted bar code; and a main server for receiving and storing bar code recognition information containing the recognition time of the bar code and bar code interpretation information containing the creation time of the bar code.

According to another aspect of the present invention, there is provided a method of authenticating a bar code comprising: a first step for allowing a main server to transmit a bar code generating program to a mobile terminal; a second step for allowing a bar code reader to recognize and interpret a bar code created by the mobile terminal; a third step for allowing the bar code reader to transmit bar code recognition information containing a recognition time of the recognized bar code and bar code interpretation information containing a creation time of the interpreted bar code; and a fourth step for allowing the main server verify validity of the bar code using the recognition time of the bar code and the creation time of the bar code.

According to another aspect of the present invention, there is provided a method of authenticating a bar code comprising: a first step for allowing a main server to transmit a bar code generating program to a mobile terminal; a second step for allowing a bar code reader to recognize and interpret a bar code created by the mobile terminal; a third step for allowing the bar code reader to verify validity of the bar code using a recognition time of the recognized bar code and a creation time of the interpreted bar code; and a fourth step for allowing the bar code reader to transmit bar code recognition information containing the recognition time of the bar code and bar code interpretation information containing the creation time of the interpreted bar code to the main server.

According to another aspect of the present invention, there is provided a bar code authentication system comprising: a bar code reader for recognizing and interpreting a bar code containing personal identification information and OTP code information created by a mobile terminal, and transmitting the personal identification information and the OTP code information; and a main server for creating confirmative OTP code information using a private key corresponding to the personal identification information and time information when the transmitted OTP code information is created, the time being contained in the transmitted OTP code information, and determining authenticity of the transmitted OTP code information by comparing the created confirmative OTP code information with the transmitted OTP code information.

According to another aspect of the present invention, there is provided a bar code authentication system comprising: a bar code reader for recognizing and interpreting a bar code containing personal identification information and OTP code information created by a mobile terminal, creating confirmative OTP code information using a private key corresponding to the personal identification information and time information when the recognized OTP code information is created, the time being contained in the recognized OTP code information, and determining authenticity of the recognized OTP code information by comparing the created confirmative OTP code information with the OTP code information recognized from the mobile terminal; and a main server for transmitting the private key corresponding to the personal identification information to the bar code reader in response to a request of the bar code reader.

According to another aspect of the present invention, there is provided a method of authenticating a bar code comprising the steps of: allowing a bar code reader to recognize the bar code containing personal identification information and OTP code information created by a mobile terminal; allowing the bar code reader to transmit the personal identification information and the OTP code information to a main server; allowing the main server to create confirmative OTP code information using a private key corresponding to the personal identification information and time information when the transmitted OTP code information is created, the time being contained in the transmitted OTP code information; and allowing the main server to determine authenticity of the transmitted OTP code information by comparing the confirmative OTP code information with the transmitted OTP code information.

According to another aspect of the present invention, there is provided a method of authenticating a bar code comprising the steps of: allowing a bar code reader to recognize the bar code containing personal identification information and OTP code information created by a mobile terminal; allowing the bar code reader to transmit the personal identification information to a main server; allowing the bar code reader to receive a private key corresponding to the personal identification information from the main server; allowing the bar code reader to create confirmative OTP code information using the private key and time information when the recognized OTP code information was created, the time being contained in the recognized OTP code information; and allowing the bar code reader to determine authenticity of the recognized OTP code information by comparing the confirmative OTP code information with the recognized OTP code information.

### [Advantageous Effects]

The bar code authentication system and method according to the present invention is effective in that forgery and falsification of a bar code created in a mobile terminal can be prevented.

Further, the present invention is effective in that the bar code containing personal information and OTP code information can be used for financial services where security is required.

Further, the present invention is effective in that members at a remote place and users of predetermined services can be effectively managed.

### DESCRIPTION OF DRAWINGS

FIG. 1 is a view showing the configuration of a bar code authentication system according to an embodiment of the present invention;

FIG. 2 is a view showing the configuration of a bar code authentication system according to another embodiment of the present invention;

FIG. 3 is a view showing the configuration of a bar code reader according to an embodiment of the present invention;

FIG. 4 is a flowchart illustrating the method of authenticating a bar code according to an embodiment of the present invention; and

FIG. 5 is a flowchart illustrating the method of authenticating a bar code according to another embodiment of the present invention.

### EXPLANATION ON THE REFERENCE NUMERALS IN THE MAIN PARTS OF THE DRAWING

110: mobile terminal 120: bar code reader 130: main server

111: external memory 210: bar code recognition unit

220: information interpreting unit

230: transmitting and receiving unit

### [Mode for Invention]

The terms and the words used in the specification and the claims should not be limitedly construed with ordinary or lexical meaning. Rather, they should be construed with the meanings and the conceptions according to the idea of the present invention, abiding by the principle that an inventor can properly define the conception of terms so as to describe his or her own invention with the best manner.

While the present invention has been described with reference to particular illustrative embodiments, it is not to be restricted by the embodiments but only by the appended claims. It is to be appreciated that those skilled in the art can change or modify the embodiments without departing from the scope and spirit of the present invention.

Hereinafter, the preferred embodiments of the present invention will be described in detail with reference to the accompanying drawings.

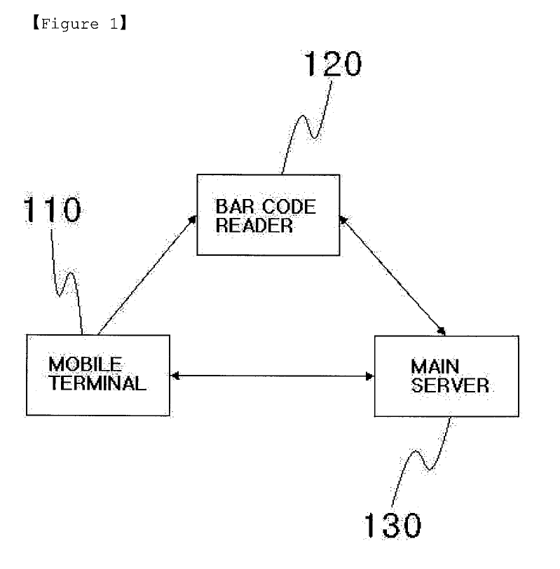

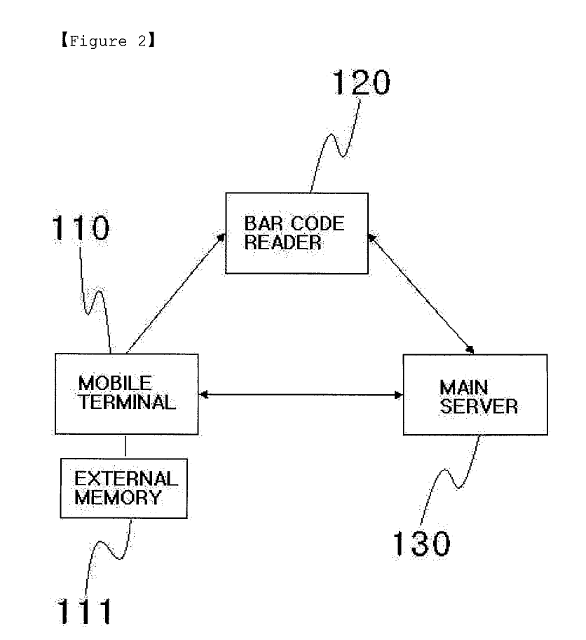

FIG. 1 is a view showing the configuration of a bar code authentication system according to an embodiment of the present invention, and FIG. 2 is a view showing the configuration of a bar code authentication system according to another embodiment of the present invention. Referring to FIGS. 1 and 2, a bar code authentication system comprises a main server 130, a bar code reader 120, and a mobile terminal 110.

According to an embodiment of the present invention, a main server 130 transmits a bar code generating program, through a mobile communication system, to a member's mobile terminal 110 registered in the main server 130.

The mobile terminal 110 downloads the bar code generating program from the main server 130 and stores the downloaded bar code generating program in an internal memory. The mobile terminal can execute the stored bar code generating program and display the generated bar code on the display unit of the mobile terminal 110. In addition, the bar code generating program may not be downloaded from the main server 130, but can be preinstalled in the internal memory of the mobile terminal 110 and executed through the mobile terminal 110.

The bar code reader 120 recognizes the bar code displayed on the display unit of the mobile terminal 110 and transmits certain necessary data to the main server 130, together with the information interpreted from the bar code.

The main server 130 has a database for storing information about members to be managed, i.e., personal identification information, such as the name of a member, resident identification number, mobile terminal identification number, and the like. Each member can download the bar code generating program to his or her mobile terminal 110 from the main server 130 after inputting certain information into the main server 130 and going through a certain confirmation procedure, i.e., a person authentication procedure.

For example, a member can input personal identification information into the main server 130 in order to download the bar code generating program from the main server 130. The main server 130 performs a certain person authentication procedure so that the member connected to the main server 130 can download the bar code generating program if the inputted personal identification information agrees with the information stored in the database.

Here, the bar code generating program downloaded to the mobile terminal 110 is programmed in a form that can be executed in the mobile terminal 110. For example, the bar code generating program is programmed to be executed on a wireless internet platform for interoperability (WIPI) or a binary runtime environment for wireless (BREW) platform. These are only examples, and the bar code generating program can be any kind of program that is programmed to be executed in the mobile terminal 110.

The member, whenever necessary, installs the bar code generating program downloaded to his or her mobile terminal 110 and simply executes the bar code generating program in the mobile terminal 110 to generate a bar code containing certain information without connecting to the main server 130 repeatedly. Accordingly, the member directly executes the bar code generating program in the mobile terminal 110 in order to create a bar code, without connecting to the main server 130 every time, and thus it is advantageous in that the process of creating a bar code is simplified and additional costs for connecting to the main server 130 are not needed.

The created bar code includes personal identification information of the owner of the mobile terminal 110, i.e., the member, bar code creation date and time, equipment information of the mobile terminal 110, an OTP code required for electronic commerce, and other additional information of data values necessary for person authentication or member management. At this point, the information included in the created bar code is desirable to be created in the encoded bar code.

Here, an OTP code is created in the same manner as creating the bar code by executing an OTP code generating program downloaded to the mobile terminal 110 from the main server 130 that can provide contents. The OTP code generating program can be downloaded from the main server 130 and stored in the internal memory of the mobile terminal 110, or preinstalled in the internal memory of the mobile terminal 110 without being downloaded from the main server 130, and executed through the mobile terminal 110.

The OTP code created by the OTP code generating program is contained as a piece of information in a bar code created by the bar code generating program.

The main server 130 receives from the bar code reader 120 such information as bar code interpretation information containing OTP code information, personal identification information of a member, and a bar code creation time, which are interpreted from the bar code that is read from the mobile terminal 110 by the bar code reader 120. The information that the main server receives also includes bar code recognition information containing a bar code recognition time, i.e., the time when the bar code reader reads the bar code, and equipment information of the bar code reader 120 (including location information on the location where the bar code reader is mounted).

The main server 130 compares, among the information transmitted from the bar code reader 120, the bar code creation time and the bar code recognition time, i.e., the time when the bar code reader 120 recognizes the bar code. If the time difference is larger than a certain reference time, the information transmitted from the bar code reader 120, i.e., recognition of the corresponding bar code, is invalidated. For example, if the bar code is recognized by the bar code reader 120 five minutes after the bar code is created, the bar code is regarded as being fraudulently used, and thus the transmitted information may not be used for member management. Meanwhile, the reference time can be arbitrarily set.

That is, reliability of person authentication can be enhanced by excluding the case where a bar code created by the bar code generating program and displayed on the display unit of the mobile terminal 110 is printed or outputted after being photographed, and then lent to others or fraudulently used.

In addition, the process of comparing the bar code creation time with the bar code recognition time performed in the main server 130 can be performed within the bar code reader 120.

That is, the bar code reader 120 that receives a bar code containing its creation time determines validity of the bar code by comparing the bar code recognition time when the bar code is recognized with the creation time. If it is determined that the recognized bar code is valid to be used, the bar code reader transmits its equipment information (including location information), bar code recognition information, bar code interpretation information, and the like to the main server 130.

Here, the bar code transmitted from the mobile terminal 110 can be created after being encoded, and the bar code reader 120 decodes only the creation time and uses the decoded creation time, together with the bar code recognition time of the bar code recognized by the bar code reader, to determine validity of the bar code. Next, since the initially encoded bar code transmitted to the bar code reader 120 from the mobile terminal 110 is valid to be used, the bar code is transmitted to the main server 130, and the main server 130 decodes the bar code and uses the decoded bar code for member management.

The mobile terminal 110 can be a mobile apparatus owned by a management target member, which is capable of communicating with the main server 130 and has a display unit for displaying a created bar code. For example, the mobile terminal 130 can be a cellular phone or a personal data assistant (PDA), or can be any kind of apparatus that is configured to communicate with a server on the web, execute the bar code generating program and the OTP code generating program, and display created bar codes.

Meanwhile, OTP code information contained in the bar code created by the mobile terminal 110 is created based on personal identification information of a member, current time information when it was created, and a private key.

Here, the private key is the information managed after having stored both in the main server 130 and in a member's mobile terminal 110 when the member initially registered in the main server 130. The private key is utilized for determining authenticity of OTP code information as well as creating the OTP code information. In addition, the private key can be created in the main server 130 and transmitted to a member's mobile terminal 110, and the said private key is utilized as an encoding key when the OTP code information is created.

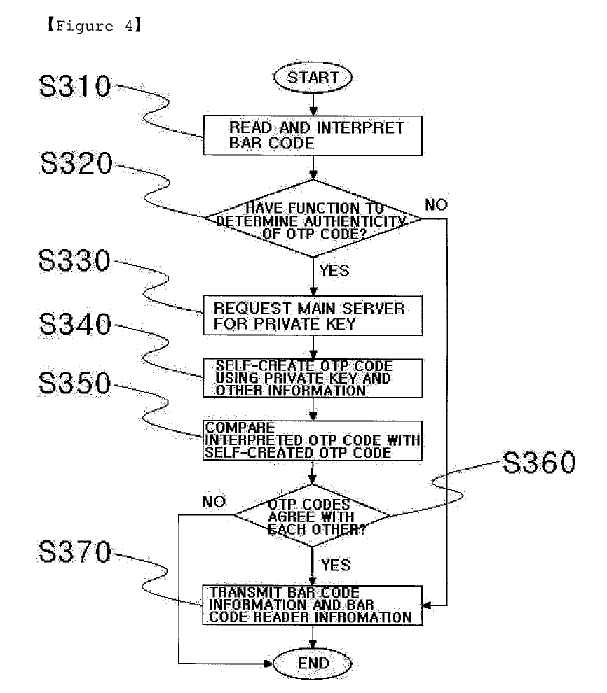

Details of determining authenticity of the OTP code information are described with reference to FIG. 4.

According to another embodiment of the present invention, the bar code generating program and the OTP code generating program can be downloaded from the main server 130, stored in the external memory 111 that can be mounted on the mobile terminal 110, and executed by the mobile terminal 110.

In addition, the bar code generating program and the OTP code generating program may not be downloaded from the main server 130, but can be preinstalled in the external memory 111 that can be mounted on the mobile terminal 110, and executed by the mobile terminal 110.

A bar code created by executing the bar code generating program and the OTP code generating program is displayed on the display unit of the mobile terminal 110.

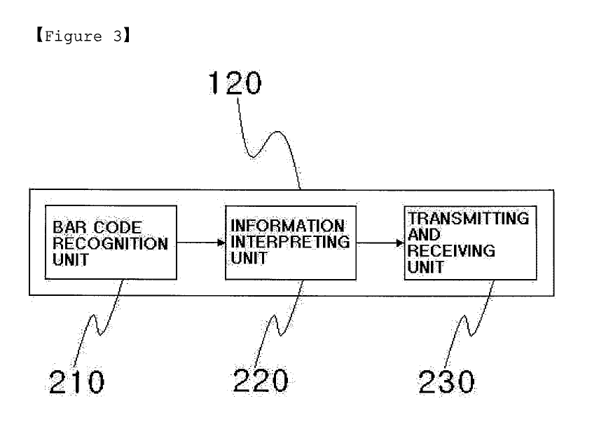

FIG. 3 is a view showing the configuration of a bar code reader according to an embodiment of the present invention. Referring to FIG. 3, the bar code reader 120 comprises a bar code recognition unit 210 for recognizing a bar code displayed on the mobile terminal 110, an information interpreting unit 220 for interpreting the information contained in the recognized bar code, and a transmitting and receiving unit 230 for transmitting the interpreted information and its equipment information to the main server 130 and receiving a private key for determining authenticity of OTP code information from the main server 130.

The bar code recognition unit 210 is an apparatus capable of recognizing a bar code, which preferably can be a camera module. Such a camera module can be the same camera module as the one mounted on a general cellular phone, or any kind of camera module with a resolution enough to identify the pattern of a bar code. A bar code is recognized using such a camera module, and thus the bar code reader can be more miniaturized than a bar code reader using a conventional scanner.

The information interpreting unit 220 interprets the information contained in the bar code recognized by the bar code recognition unit 210 and transfers the interpreted information to the transmitting and receiving unit 230.

The transmitting and receiving unit 230 is configured to transmit the bar code interpretation information interpreted from the bar code to the main server 130, together with the bar code recognition information and equipment information, and receive a private key for determining authenticity of OTP code information from the main server 130. Meanwhile, the bar code reader 120 can have a radio controlled clock for the recognition time to be contained in the bar code recognition information. Preferably, time information can be received from the mobile terminal 110 that displays the bar code.

The transmitting and receiving unit 230 can wiredly and wirelessly communicate with the main server 130. The transmitting and receiving unit 230 can be connected to the main server 130 through a network such as a local area network (LAN), or can be connected through a short distance communication such as the Bluetooth, or a public switched telephone network (PSTN). In addition, the transmitting and receiving unit 230 can communicate with the main server 130 in a mobile communication method through a mobile communication network.

Preferably, the said mobile communication method is the code division multiple access (CDMA) method, and a CDMA module for transmitting data based on the CDMA method can be mounted on the transmitting and receiving unit 230 and the main server 130. The CDMA method is only an example, and any kind of mobile communication method that enables remote wireless communication can be used. For example, the mobile communication method can be a time division multiple access (TDMA) method or a frequency division multiple access (FDMA) method.

As described above, since data is transmitted between the transmitting and receiving unit 230 and the main server 130 in a mobile communication method, the main server 130 can receive, in real-time or in a batch, information on remote members who are not connected to the main server through a wired network such as a LAN, and manage the members in an integrated manner.

FIG. 4 is a flowchart illustrating the method of authenticating a bar code according to an embodiment of the present invention. Referring to FIG. 4, first, the mobile terminal 110 creates an OTP code using the OTP generating program stored in its internal memory or in the external memory 111. The OTP code is created using a hash function, based on the same private key stored and managed both in the main server 130 and the mobile terminal 110 when a member registers his or her personal identification information, and current time information, i.e., the time of creating the OTP code.

Next, the mobile terminal 110 creates a bar code using the bar code generating program stored in its internal memory or in the external memory 111. The created bar code contains personal identification information, OTP code information, and interpretation information of a member.

The created bar code is read S310 by the bar code reader 120 while being displayed on the display unit of the mobile terminal 110.

If the bar code reader 120 that has read the bar code has a function for determining authenticity of the OTP code S320, the bar code reader 120 transmits the personal identification information secured by interpreting the bar code S310 to the main server 130 through the transmitting and receiving unit 230, thereby requesting a private key corresponding to the personal identification information S330.

The main server 130 searches for and secures the private key corresponding to the personal identification information which is received from the bar code reader 120, and transmits the searched and secured private key to the bar code reader 120.

The bar code reader 120 creates an OTP code in a time matching method S340 using the private key received from the main server 130, the personal identification information of a member, and the read and interpreted OTP code information, and compares S350 the created OTP code information with the OTP code information read and interpreted from the mobile terminal 110.

If the created OTP code information matches with the interpreted OTP code information S360 as a result of the comparison, the bar code reader transmits S370 the read bar code information to the main server 130. If the created OTP code information does not match with the interpreted OTP code information S360, the read bar code is discarded.

On the other hand, if the bar code reader 120 that reads the bar code does not have a function for determining authenticity of the OTP code S320, the bar code reader 120 transmits S370 the bar code information that the bar code reader has read to the main server 130.

The main server 130 that receives the bar code information interprets the received bar code information, and searches for and secures the private key corresponding to the personal identification information contained in the bar code from the database (DB).

Next, the main server 130 creates an OTP code in a time matching method using the secured private key, the personal identification information of a member, and the received OTP code information, and compares the created OTP code information with the OTP code information interpreted from the bar code received from the bar code reader 120. Then, the main server notifies the result value of the comparison to the bar code reader 120.

Meanwhile, the bar code created and displayed on the display unit of the mobile terminal 110 contains an OTP code value at the lower portion. Here, the OTP code value can be a combination of numerals.

A member inputs his or her personal ID and password into an electronic commerce server and goes through general membership authentication, and inputs the OTP code value displayed on his or her mobile terminal 110 into the electronic commerce server that requests to input an OTP code for electronic commerce or membership authentication. Here, the electronic commerce server is preferably a server that administrates the homepage of electronic commerce or the like that the member desires to use.

The electronic commerce server transmits authentication information containing the inputted OTP code value and the personal identification information to the main server 130. In the same manner as determining authenticity of OTP code information, using the authentication information received from the electronic commerce server, the main server 130 creates an OTP code value corresponding to the member and determines authenticity of the received OTP code value by comparing the created OTP code value with the received OTP code value. Next, the result of the comparison is notified to the electronic commerce server.

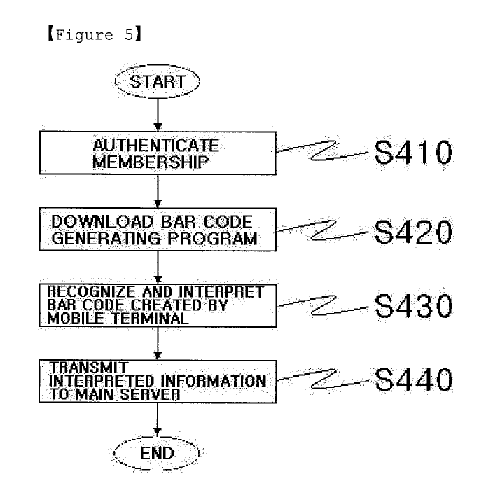

FIG. 5 is a flowchart illustrating the method of authenticating a bar code according to another embodiment of the present invention. Referring to FIG. 5, first, personal identification information, i.e., information about a management target member, such as the name, the resident identification number, the working place, the address, the mobile terminal identification number, and the like, is registered in the main server.

If each member inputs his or her personal identification information into the main server 130, the main server 130 verifies whether the personal identification information inputted by each member matches with the personal identification information of the member stored in the database, i.e., performs a person authentication procedure S410. If the inputted personal identification information accords with the preinstalled personal identification information, the main server transmits S420 the bar code generating program to the mobile terminal 110 of the member.

The mobile terminal 110 creates a bar code by executing the bar code generating program downloaded from the main server 130 and displays the created bar code on a display apparatus. Here, the said bar code contains personal identification information of the member, bar code creation date and time, equipment information of the mobile terminal, and other additional information of data values necessary for person authentication or member management.

Next, the bar code reader 120 recognizes the bar code displayed on the mobile terminal 110 and interprets the information contained in the bar code S430.

The bar code reader 120 transmits S440 the interpreted bar code information containing the personal identification information of the member, i.e., the bar code interpretation information, the bar code recognition information, and the equipment information of the bar code reader to the main server 130.

The main server 130 can manage members based on the transmitted information. In addition, the main server 130 compares the bar code creation time and the bar code recognition time through the received information, and if the difference is larger than a certain reference time, the received information can be invalidated.

Through the method described above, it is possible that a certain member creates a bar code in real-time whenever necessary by executing the bar code generating program downloaded from the main server 130, and that the created bar code is invalidated if the time difference between the bar code creation time and the bar code recognition time is larger than a certain reference time. Therefore, reliability of person authentication can be enhanced by preventing a third person from using the bar code displayed on the mobile terminal 110. In addition, since data showing that a member had stayed at a specific location at a specific time is transmitted to the main server 130, it is easy to remotely manage employee work attitudes, attendance, and the like of specific members.

In addition, preferably, the bar code generating program can create encoded bar code and the created bar code can be displayed on a mobile apparatus such as a cellular phone. The encoded bar code can be decoded by the information interpreting unit 220 of the bar code reader 120 or decoded through a separate procedure in the main server 130. Therefore, reliability of person authentication can be further enhanced by using such encoding and decoding schemes.

If a management target member or worker cancels membership or quits employment, registration can be easily cancelled by simply deleting information of the member or the worker from the main server 130. In addition, if a new member or a worker joins membership or the company, information of the member or the worker can be simply stored or registered into the main server 130. Accordingly, the new member only needs a procedure to download the bar code generating program from the main server 130, and thus remote members can be managed without any additional procedure.

Such a method of bar code authentication can be used for commercial payment or the like where stability of person identification is important, as well as for services that need periodic checks, such as gas metering, and for secured taxi services. Other than these services, the method of bar code authentication can be used for all the cases where person authentication is regarded as an important requirement in managing of members.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A bar code authentication system comprising:
a bar code reader for recognizing and interpreting a bar code created by a mobile terminal, and transmitting bar code recognition information containing the recognition time of the recognized bar code and bar code interpretation information containing the creation time of the interpreted bar code; and
a main server for verifying validity of the bar code using the recognition time of the bar code and the creation time of the bar code.

2. A bar code authentication system comprising:
a bar code reader for recognizing and interpreting a bar code created by a mobile terminal, and verifying validity of the bar code using the recognition time of the recognized bar code and the creation time of the interpreted bar code; and
a main server for receiving and storing bar code recognition information containing the recognition time of the bar code and bar code interpretation information containing the creation time of the bar code.

3. The system according to claim 1 or 2, wherein the bar code recognition information further contains location information of the bar code reader.

4. The system according to claim 1 or 2, wherein the said bar code interpretation information further contains personal identification information of the user of the said mobile terminal.

5. The system according to claim 1 or 2, wherein the said verification is determining whether the time difference between the recognition time of the bar code and the creation time of the bar code is smaller than a certain time period.

6. The system according to claim 1 or 2, wherein the said bar code reader includes:
a transmission unit for transmitting the said bar code recognition information and the said bar code interpretation information to the main server through a public switched telephone network or a mobile communication network;
a bar code recognition unit provided with a camera module for recognizing the bar code; and
a bar code interpreting unit for interpreting the recognized bar code.

7. The system according to claim 1 or 2, wherein the said main server transmits a bar code generating program to the mobile terminal after performing person authentication of the user of the mobile terminal.

8. The system according to claim 7, wherein the said bar code generating program encodes and creates a bar code, and the encoded bar code is decoded by the bar code reader or the main server.

9. The system according to claim 8, wherein the mobile terminal stores the bar code generating program into its internal memory or into an external memory.

10. A method of authenticating a bar code comprising:
a first step of allowing a main server to transmit a bar code generating program to a mobile terminal;
a second step of allowing a bar code reader to recognize and interpret a bar code created by the mobile terminal;
a third step of allowing the bar code reader to transmit bar code recognition information containing the recognition time of the recognized bar code and bar code interpretation information containing the creation time of the interpreted bar code to the main server; and
a fourth step of allowing the main server to verify validity of the bar code using the recognition time of the bar code and the creation time of the bar code.

11. A method of authenticating a bar code comprising:
a first step of allowing a main server to transmit a bar code generating program to a mobile terminal;
a second step of allowing a bar code reader to recognize and interpret a bar code created by the mobile terminal;
a third step of allowing the bar code reader to verify validity of the bar code using a recognition time of the recognized bar code and a creation time of the interpreted bar code; and
a fourth step of allowing the bar code reader to transmit bar code recognition information containing the recognition time of the bar code and bar code interpretation information containing the creation time of the interpreted bar code to the main server.

12. The method according to claim 10 or 11, wherein the first step comprises the steps of allowing the main server:
to receive personal identification information of the user of the mobile terminal from the mobile terminal;
to perform person authentication of the user of the mobile terminal using the personal identification information; and
to transmit the bar code generating program to the mobile terminal.

13. The method according to claim 10 or 11, wherein the bar code recognition information further contains location information of the bar code reader.

14. The method according to claim 10 or 11, wherein the bar code interpretation information further contains personal identification information of the user of the mobile terminal.

15. The method according to claim 10 or 11, wherein the verification is determining whether a time difference between the recognition time of the bar code and the creation time of the bar code is smaller than a certain time period.

16. The method according to claim 10 or 11, wherein the bar code recognition of the second step is performed through a camera module of the bar code reader.

17. The method according to claim 10 or 11, wherein the transmission is performed through a public switched telephone network or a mobile communication network.

18. The method according to claim 10 or 11, wherein the bar code generating program encodes and creates a bar code, and the encoded bar code is decoded by the bar code reader or the main server.

19. The method according to claim 18, wherein the mobile terminal stores the bar code generating program into its internal memory or into an external memory.

20. A bar code authentication system comprising:
a bar code reader for recognizing and interpreting a bar code containing personal identification information and OTP code information created by a mobile terminal, and transmitting the personal identification information and the OTP code information; and
a main server for creating confirmative OTP code information using a private key corresponding to the personal identification information and time information when the transmitted OTP code information was created, the time being contained in the transmitted OTP code information, and determining authenticity of the transmitted OTP code information by comparing the created confirmative OTP code information with the transmitted OTP code information.

21. A bar code authentication system comprising:
a bar code reader for recognizing and interpreting a bar code containing personal identification information and OTP code information created by a mobile terminal, creating confirmative OTP code information using a private key corresponding to the personal identification information and time information when the recognized OTP code information was created, the time being contained in the recognized OTP code information, and determining authenticity of the recognized OTP code information by comparing the created confirmative OTP code information with the OTP code information recognized from the mobile terminal; and
a main server for transmitting the private key corresponding to the personal identification information to the bar code reader in response to the request of the bar code reader.

22. The system according to claim 20 or 21, wherein the mobile terminal has a private key that is the same as the private key of the bar code reader, creates the OTP code information using its private key, the personal identification information, and current time information, and adds the created OTP code information into the bar code.

23. The system according to claim 22, wherein the mobile terminal stores an OTP code generating program for creating the OTP code information, a bar code generating program for creating the bar code, and the private key into its internal memory or into an external memory.

24. A method of authenticating a bar code comprising the steps of:
allowing a bar code reader to recognize the bar code containing personal identification information and OTP code information created by a mobile terminal;
allowing the bar code reader to transmit the personal identification information and the OTP code information to a main server;
allowing the main server to create confirmative OTP code information using a private key corresponding to the personal identification information and time information when the transmitted OTP code information is created, the time being contained in the transmitted OTP code information; and
allowing the main server to determine authenticity of the transmitted OTP code information by comparing the confirmative OTP code information with the transmitted OTP code information.

25. A method of authenticating a bar code comprising the steps of:
allowing a bar code reader to recognize the bar code containing personal identification information and OTP code information created by a mobile terminal;
allowing the bar code reader to transmit the personal identification information to a main server;
allowing the bar code reader to receive a private key corresponding to the personal identification information from the main server;
allowing the bar code reader to create confirmative OTP code information using the private key and time information when the recognized OTP code information was created, the time being contained in the recognized OTP code information; and
allowing the bar code reader to determine authenticity of the recognized OTP code information by comparing the confirmative OTP code information with the recognized OTP code information.

26. The method according to claim 24 or 25, wherein the mobile terminal has a private key that is the same as the private key of the bar code reader, creates the OTP code information using its private key, the personal identification information, and current time information, and adds the created OTP code information into the bar code.

27. The method according to claim 26, wherein the mobile terminal stores an OTP code generating program for creating the OTP code information, a bar code generating program for creating the bar code, and the private key into its internal memory or into an external memory.
